(19) United States
(12) Patent Application Publication
(10) Pub. No.: US 2022/0009126 A1
(43) Pub. Date: Jan. 13, 2022

(54) MULTI-LINE CUTTING METHOD, MULTI-LINE CUTTING APPARATUS AND USE THEREOF, SEMICONDUCTOR MATERIAL AND POWER DEVICE

(71) Applicant: FUJIAN NORSTEL MATERIAL TECHNOLOGIES CO., LTD, Fujian (CN)

(72) Inventors: Bofan LAI, Fujian (CN); Jie ZHANG, Fujian (CN); Wuqing LIN, Fujian (CN)

(21) Appl. No.: 17/424,713

(22) PCT Filed: Oct. 14, 2019
(86) PCT No.: PCT/CN2019/111082

§ 371 Date: Jul. 21, 2021

(30) Foreign Application Priority Data
Jan. 23, 2019 (CN) 201910065853.6

(51) Int. Cl. B28D 5/04; B28D 5/00

(52) U.S. Cl. CPC B28D 5/047; B28D 5/0082; B28D 5/045

(57) ABSTRACT

A multi-line cutting method, a multi-line cutting apparatus and use thereof, a semiconductor material and a power device. The multi-line cutting method includes following steps: configuring a line spool for winding cutting lines to vibrate under the excitation action of ultrasonic waves; and vibrating the cutting lines to cut an object to be cut under the conveying action of the line spool. The vibration of the cutting line under the excitation action of the ultrasonic waves can increase the energy of the cutting lines, enhance the cutting capability of the cutting lines, reduce the abrasion of the cutting lines, and force abrasive materials to impact and grind said object at high frequency and speed, and the chip removal speed is high, so that the surface curvature, the surface warpage, and the total thickness deviation of a product obtained after cutting are all small, and the cutting quality is high.

### CROSS-REFERENCE TO RELATED APPLICATION

The present disclosure claims priority of Chinese patent application with the filing number 201910065853.6 filed on Jan. 23, 2019 with the Chinese Patent Office, and entitled “multi-line cutting method, multi-line cutting apparatus and use thereof, semiconductor material and power device”, the contents of which are incorporated herein by reference in entirety.

### TECHNICAL FIELD

The present disclosure relates to technical field of multi-line cutting, in particular, to a multi-line cutting method, multi-line cutting apparatus and use thereof, semiconductor material and power device.

### BACKGROUND ART

The third-generation wide-bandgap semiconductor materials (such as single crystal silicon carbide) have excellent performance. In recent years, they have rapidly penetrated into the fields such as lighting, power devices, microwave and radio frequency, have broad application prospects in manufacturing high-frequency and high-power devices that are resistant to high temperature and radiation, and have become the focus of the international attention. At present, in the manufacturing and epitaxial growth of next-generation power devices, there are strict requirements on the final surface quality of the substrate material. However, due to the high hardness of the above-mentioned semiconductor materials (for example, the Mohs hardness of SiC crystal is 9.2, the second only for diamond), the chemical stability is very good (it hardly has obvious chemical reaction with other substances at room temperature), so the semiconductor substrate is difficult to be processed for obtaining. Among them, the multi-line cutting process has the greatest effect on the cutting quality, directly affects the post-processing yield rate, and even affects the epitaxial stability. Therefore, it is necessary to further improve the multi-line cutting process.

In view of this, the present disclosure is hereby submitted.

### SUMMARY

One of purposes of the present disclosure is to provide a multi-line cutting method, the cutting quality of the multi-line cutting method is stable, the product processed to be obtained by the multi-line cutting method has fewer geometric defects, and the warpage, curvature and thickness deviation of a product are all small.

The multi-line cutting method provided in the present disclosure includes the following steps: making a line spool configured to be winded by cutting lines vibrate under the excitation action of ultrasonic waves; and making the cutting lines vibrate to cut an object to be cut under the transmitting action of the line spool.

Further, the cutting line resonates with the ultrasonic waves transmitted to the cutting line.

Further, a vibrating component of ultrasonic generating device is contacted with the line spool to realize the loading of ultrasonic waves.

Further, the cutting line resonates with the ultrasonic waves transmitted to the cutting line.

Further, the vibration frequency of the ultrasonic wave is 20-300 kHz, preferably 25-120 kHz;

Preferably, the vibration amplitude of the cutting line is 1-650 μm;

Preferably, the diameter of the cutting line is 0.05-0.3 mm;

Preferably, the moving speed of the cutting line is 350-1500 m/min, further preferably, 400-1200 m/min;

Preferably, the tension of the cutting line is 25-45 N;

Preferably, the material of the cutting line includes at least one of single crystal diamond, polycrystalline diamond and piano wire, preferably, single crystal diamond or polycrystalline diamond.

Further, the object to be cut includes at least one of silicon carbide, sapphire, gallium nitride, and silicon;

Preferably, the feeding speed of the object to be cut is 0.5-15 mm/hr.

The second purpose of the present disclosure is to provide a multi-line cutting apparatus, wherein the multi-line cutting apparatus comprises at least two parallel line spools arranged at intervals; cutting lines, winding around the line spools; and an ultrasonic generating device, wherein the vibrating component of the ultrasonic generating device is in contact with at least one of the line spools.

Preferably, the line spool is in a hollow structure, and the vibrating component is located in the hollow structure.

The third purpose of the present disclosure is to provide a use of the aforementioned multi-line cutting apparatus for cutting semiconductor materials.

The fourth purpose of the present disclosure is to provide a semiconductor material, wherein the semiconductor material is cut to be obtained by using the aforementioned the multi-line cutting method or the aforementioned multi-line cutting apparatus. The semiconductor material has a surface with fewer geometric defects and high product yield rate.

The fifth purpose of the present disclosure is to provide a power device, the power device includes the aforementioned semiconductor material. The power device has a high product yield rate and good performance.

Compared with the prior art, the present disclosure has the following beneficial effects.

The vibration of the cutting line under the excitation action of the ultrasonic waves can significantly increase the energy of the cutting lines, enhance the cutting capability of the cutting lines, when vibrating, the cutting line can force abrasive materials to impact and cut object to be cut at high frequency and speed, and the chip removal speed is high, during the cutting process, the cutting line has lower abrasion and wears evenly, and there is almost no phenomenon of wire breakage, so that the surface curvature, the surface warpage, and the total thickness deviation of a product obtained after cutting are all small, and the cutting quality is high.

### BRIEF DESCRIPTION OF DRAWINGS

In order to more clearly illustrate technical solutions in the specific embodiments of the present disclosure or the prior art, accompanying drawings which need to be used for description of the specific embodiments or the prior art will be introduced briefly below, and apparently, the accompanying drawings in the following description merely show some embodiments of the present disclosure, and those ordinarily skilled in the art still could obtain other drawings in light of these accompanying drawings, without using any inventive efforts.

FIG. 1 is a schematic view of multi-line cutting of an object to be cut in an embodiment of the present disclosure;

FIG. 2 is a schematic view of ultrasonic wave transmission in an embodiment of the present disclosure; and

FIG. 3 is a schematic view of multi-line cutting apparatus in an embodiment of the present disclosure.

Reference signs: 10—cutting line; 20—line spool; 30—object to be cut; 40—workbench for fixing object to be cut; 50—vibrating component.

### DETAILED DESCRIPTION OF EMBODIMENTS

The embodiments of the present disclosure will be described in detail below in conjunction with examples, but those skilled in the art will understand that the following examples are only used to illustrate the present disclosure and should not be regarded as limiting the scope of the present disclosure. If specific conditions are not indicated in the embodiments, it shall be carried out in accordance with the conventional conditions or the conditions recommended by the manufacturer.

In the present disclosure, if there is no special description, all the embodiments and preferred implementation methods mentioned herein can be combined with each other to form a new technical solution.

In the present disclosure, if there is no special description, all the technical features and preferred features mentioned herein can be combined with each other to form a new technical solution.

In the present disclosure, if there is no special description, percentage (%) or part refers to the weight percentage or weight part relative to the composition.

In the present disclosure, if there is no special description, the involved each component or their preferred components can be combined with each other to form a new technical solution.

In the present disclosure, unless otherwise specified, the numerical range “a˜b” represents the abbreviated representation of any combination of real numbers between a and b, wherein both a and b are real numbers. For example, the numerical range “6-22” represents that all real numbers between “6-22” have been all listed herein, and “6-22” is only an abbreviated representation of these numerical combinations.

The “range” disclosed in the present disclosure is in the form of lower limit and upper limit, which can be one or more lower limits and one or more upper limits, respectively.

Unless otherwise specified, the professional and scientific terms used herein have the same meaning as those familiar to those skilled in the art. In addition, any method or material similar or equivalent to the content recorded can also be applied to the present disclosure.

In one aspect of the present disclosure, the present disclosure provides a multi-line cutting method, the multi-line cutting method includes the following steps: making a line spool configured to be winded by cutting lines vibrate under the excitation action of ultrasonic waves; and making the cutting lines vibrate to cut an object to be cut under the transmitting action of the line spool.

The inventor of the present disclosure found that ultrasonic waves can transmit its energy to the cutting line through the line spool relative stably, which can significantly increase the energy of the cutting lines, enhance the cutting capability of the cutting lines, when vibrating, the cutting line can force abrasive materials to impact and grind object to be cut at high frequency and speed, and the chip removal speed is high, the cutting line has lower abrasion and wears evenly, and there is almost no phenomenon of wire breakage, so that the surface curvature, the surface warpage, and the total thickness deviation of a product obtained after cutting are all small, and the cutting quality is high.

In some preferred embodiments of the present disclosure, a vibrating component of the ultrasonic generating device is contacted with the line spool to realize the loading of ultrasonic waves. Thus, the vibration of the vibrating component drives line spool to vibrate, and the ultrasonic wave is stably transmitted to the cutting line under the transmission action of the line spool. It should be noted that due to the influence of the volume and quality of the line spool itself, when ultrasonic waves are loaded on the line spool, there is little effect on their own vibration, and the role of the line spool is mainly represented as the role of a transmission medium.

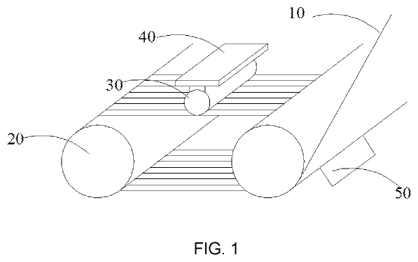

In some specific embodiments of the present disclosure, referring to FIG. 1, the cutting line 10 is evenly wound on two parallel line spools 20 arranged at intervals to realize multi-line cutting, the line spool 20 fixing the cutting line 10 is in contact with vibrating component 50 of the ultrasonic generating device directly, when vibrating component 50 vibrates at a certain frequency, the line spool 20 serves as a transmission medium to transmit ultrasonic waves to the cutting line 10, thereby causing the cutting line 10 to vibrate, the object to be cut 30 moves toward the cutting line 10 under the driving of the workbench for fixing the object to be cut 40, finally the cutting of the object to be cut 30 is realized. It should be noted that, in the present disclosure, the positions of other structures in ultrasonic generating device except for the vibrating component can be set according to actual conditions, which will not be repeatedly described here.

The inventor of the present disclosure found that, compared to the method of directly contacting the vibrating component of the ultrasonic generating device with the cutting line to realize the vibration of the cutting line, the method of the present disclosure can effectively prolong the service life of the ultrasonic generating device without the phenomenon that the cutting line wears the vibrating component, and multi-line cutting can be realized. The distribution of ultrasonic waves on cutting line is relatively uniform, and the cutting line can maintain a strong and stable cutting ability during the entire cutting process; and compared to the method of contacting the vibrating component of the ultrasonic generating device with the object to be cut or the workbench for fixing the object to be cut to realize the vibration of the cutting line, the energy attenuation in the transmission process of the ultrasonic wave in the present disclosure is less, and the energy of the ultrasonic wave transmitted to cutting line is high, and the cutting efficiency is higher.

In the present disclosure, there is no particular restriction on the way that the vibrating component contacts with the line spool, as long as the requirements can be met, those skilled in the art can make flexible selections according to actual needs. In some preferred embodiments of the present disclosure, the line spool is in a hollow structure, and the vibrating component can be placed in the hollow structure of the line spool and contacted with line spool, thereby simplifying the structure and facilitating the line spool to efficiently and stably transmit ultrasonic waves, and the vibrating components are not easily affected by other structures, ensuring the stability of the entire system.

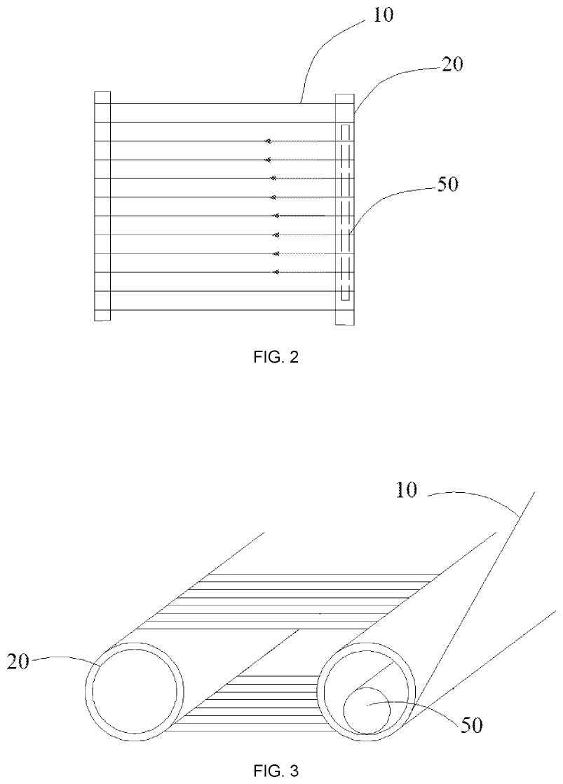

In some embodiments of the present disclosure, the way that the ultrasonic wave transmits its energy to the cutting line through the line spool can refer to FIG. 2. The vibrating component 50 of the ultrasonic generating device vibrates at a certain frequency, the line spool 20 contacting with the vibrating component 50 serves as a transmission medium to transmit ultrasonic waves to the cutting line 10, so that the multiple cutting lines 10 wound on the line spool 20 vibrate at the same time, and the ultrasonic waves are transmitted along the cutting line 10 in a direction away from the vibrating component 50, thereby achieving the effect of high-quality and efficient multi-line cutting.

It is understandable that cutting line itself has a certain range of natural vibration frequency (i.e., natural frequency), when vibration frequency of the ultrasonic waves (such as sinusoidal ultrasonic waves) transmitted to cutting line is the same as or overlapping with the natural vibration frequency of the cutting line itself, the cutting line resonates with the ultrasonic wave, which increases the vibration amplitude and vibration intensity of the cutting line, thereby improving the cutting ability of the cutting line. Based on this, in some preferred embodiments of the present disclosure, the cutting line resonates with ultrasonic waves transmitted to the cutting line. Thus, during cutting process, the vibration amplitude of the cutting line is moderately increased, the cutting ability of the cutting line is stronger, chip removal ability of the cutting system is stronger, it is easier to reduce wear, improve the cutting quality, and the effect of solving the wire breakage problem of the cutting line is more obvious.

When the vibration frequency of ultrasonic wave matches with the natural frequency of the cutting line, the generated vibration effect is the strongest. Therefore, the vibration frequency of the input ultrasonic wave can be selected and optimized according to the natural frequency of the cutting line. In some preferred embodiments of the present disclosure, the vibration frequency of ultrasonic wave is 20-300 kHZ (for example, 20 kHz, 22 kHz, 24 kHz, 26 kHz, 28 kHz, 30 kHz, 50 kHz, 100 kHz, 150 kHz, 200 kHz, 250 kHz or 300 kHz), therefore, the energy of the ultrasonic wave transmitted to cutting line is high, which can effectively drive the cutting line to vibrate and effectively improve the cutting ability of the cutting line, the performance of the chip removal is significantly improved, the wire breakage problem and cutting quality of the cutting line are improved significantly. Compared with above-mentioned vibration frequency range, when vibration frequency of the ultrasonic waves is too low, the vibration frequency of the cutting line is correspondingly lower, the performance of the chip removal is relatively poor, and cutting quality is relatively lower; when the vibration frequency of the ultrasonic wave is too high, then the vibration frequency of the cutting line is too high, resulting in relatively obvious geometric defects on the surface of the product obtained after cutting. In some more preferred embodiment of the present disclosure, the vibration frequency of ultrasonic wave is 25-120 kHz. Thus, the effect of improving the cutting quality of the cutting line is better.

In some embodiments of the present disclosure, in order to make the cutting ability of the cutting line stronger, the diameter of the cutting line is 0.05-0.3 mm (such as 0.05 mm, 0.1 mm, 0.15 mm, 0.2 mm, 0.25 mm or 0.3 mm). Thus, the diameter of the cutting line is appropriate, and its natural frequency is easy to match the frequency of the above-mentioned ultrasonic wave, and it is easier to resonate with the ultrasonic wave transmitted to the cutting line, at the resonance frequency, the vibration energy is high and the vibration amplitude is appropriate, which is conducive to chip removal, and the cutting ability is excellent. Compared with the above-mentioned diameter range, when the diameter of the cutting line is too small, the vibration amplitude is too large when the cutting line is vibrating, which is not conducive to improving the cutting quality and relatively easy to be wire breakage; when the diameter of the cutting line is too large, the vibration amplitude is too small when the cutting line is vibrating, which is not conductive to chip removal, and the effect of improving the cutting quality is relatively poor.

In some embodiments of the present disclosure, the tension of the cutting line is 25-45N (such as 25N, 30N, 35N, 40N or 45N). Thus, the cutting ability of the cutting line is stronger, and it is more suitable to match the vibration frequency of the cutting line, the chip removal ability is stronger, and the problem of wire breakage will not occur, and curvature, warpage and total thickness deviation of the product surface obtained by cutting are smaller, and the cutting quality is more excellent.

In some embodiments of the present disclosure, the vibration amplitude of the cutting line is 1-650 μm (such as 1 μm, 10 μm, 20 μm, 50 μm, 100 μm, 150 μm, 200 μm, 250 μm, 300 μm, 350 μm, 400 μm, 450 μm, 500 μm, 550 μm, 600 μm or 650 μm). Thus, the vibration amplitude of cutting line is appropriate, which can not only improve the cutting quality, promote chip removal, but also reduce the abrasion of the cutting line, without wire breakage problem, prolong the service life of the cutting line, and maintain stable cutting ability in the process of long-term use.

In some embodiments of the present disclosure, the moving speed of cutting line is 350-1500 m/min, such as 350 m/min, 450 m/min, 550 m/min, 650 m/min, 750 m/min, 850 m/min, 950 m/min, 1000 m/min, 1100 m/min, 1200 m/min, 1300 m/min, 1400 m/min or 1500 m/min. Thus, the moving speed of the cutting line is appropriate, it has a suitable natural frequency, and is suitable for matching with the frequency of ultrasonic wave transmitted to cutting line to resonate, and the tension of the cutting line is appropriate, thereby ensuring that cutting line can have a suitable cutting ability when vibrating, in order to improve the cutting quality and reduce wire breakage problem. In some preferred embodiments of the present disclosure, the moving speed of the cutting line is 400-1200 m/min. As a result, the cutting quality is higher, and curvature, warpage and total thickness deviation of the product surface obtained are smaller, and is more suitable for large-scale applications.

In some embodiments of the present disclosure, the material of the cutting line includes at least one of single crystal diamond, polycrystalline diamond and piano wire, thus, the material source of the cutting line is wide, the hardness is relatively high, and cutting effect is good. In some preferred embodiments of the present disclosure, the material of the cutting line is single crystal diamond or polycrystalline diamond. Thus, the cutting effect of the cutting line is better, and there is almost no problem of wire breakage during the cutting process.

In some embodiments of the present disclosure, the object to be cut includes at least one of silicon carbide (for example, single crystal silicon carbide), sapphire, gallium nitride, and silicon (for example, single crystal silicon). Thus, the source of the object to be cut is wide, and the cutting method described above is suitable for cutting it, so as to avoid waste of resources.

In some embodiments of the present disclosure, the feeding speed of the object to be cut is 0.5-15 mm/hr (for example, 0.5 mm/hr, 1 mm/hr, 2 mm/hr, 5 mm/hr, 8 mm/hr, 10 mm/hr, 12 mm/hr or 15 mm/hr). Thus, the feeding speed of the object to be cut has a better matching effect with the vibration of the cutting line, and the effect of improving the cutting quality is better. Relative to the above-mentioned feeding speed range, when the feeding speed of the object to be cut is too high, a short-circuit phenomenon will occur, resulting in unstable processing, the surface of the product obtained is bad, and the yield rate of product is low; when the feeding speed of the object to be cut is too low, there will be an open circuit phenomenon, which causes the processing to be unable to proceed continuously and the yield rate of the product is also low.

In some specific embodiments of the present disclosure, the Warp of the product surface obtained by utilizing the above-mentioned multi-line cutting method to cut is less than or equal to 40 microns, the Bow is less than 10 microns or Bow±10 microns, and the TTV is less than or equal to 10 microns. Thus, the cutting quality of the above method is excellent, and it is suitable for industrial application.

In some embodiments of the present disclosure, mortar cutting can be used in combination with the multi-line cutting, thus further improving cutting quality and cutting efficient, and is suitable for industrial production.

In another aspect of the present disclosure, the present disclosure provides a multi-line cutting apparatus. Referring to FIG. 3, the multi-ling cutting apparatus includes: at least two parallel line spools 20 arranged at intervals; a cutting line 10, which is wound around the line spool 20; an ultrasonic generating device, the vibrating component 50 of the ultrasonic generating device is in contact with at least one of the line spools 20. The inventor found that the multi-line cutting apparatus has a simple structure, the vibration of the vibrating component drives the line spool to vibrate, and then the ultrasonic waves are stably transmitted to the cutting line under the transmission action of the line spool, the cutting efficiency is high, there is almost no phenomenon of wire breakage, and the cutting quality is high, the service life is long, and it is easy to meet the requirements of industrialization.

It should be noted that the ultrasonic generating device, the line spool and the cutting line are consistent with the previous description, and will not be repeatedly described here. It can be understood that, in order to achieve better cutting quality, the ultrasonic waves generated by the ultrasonic generating device, the setting of the line spool, and the setting of the cutting line can be consistent with the previous description, and will not be repeatedly described here.

In some embodiments of the present disclosure, the line spool is a hollow structure, and the vibrating component is located in the hollow structure, thus, when the vibrating component vibrates at a certain frequency, it will drive the line spool to vibrate, the line spool serves as transmission medium and can transmit stably ultrasonic waves to the cutting line, thereby causing the cutting line to vibrate. The above configuration of the vibrating component can simplify the structure, and facilitate the efficient and stable transmission of ultrasonic waves by the line spool, and the vibrating component is not easily affected by other structures, the stability of the entire system is ensured, and the hollow structure of the line spool is beneficial to reduce the weight of the line spool, and is easy to realize the control of the line spool, in addition, the energy consumption of driving the line spool to operate is low, and the effect of the energy saving is good.

In some specific embodiments of the present disclosure, the vibrating component of the ultrasonic generating device may be a vibrating head, in addition to the aforementioned vibrating component, the ultrasonic generating device may also include an amplitude rod, an ultrasonic transducer, a power supply, and the like, and the positions of the amplitude rod, the ultrasonic transducer, the power supply, and the like can be set according to the actual situation, and will not be repeatedly described here.

In another aspect of the present disclosure, the present disclosure provides a use of the aforementioned multi-line cutting apparatus for cutting semiconductor materials. The inventor found that when the multi-line cutting apparatus is used to cut semiconductor materials, the cutting quality is stable, the cutting line wears less, and the wire breakage problem does not occur, and it is suitable for industrial applications.

In another aspect of the present disclosure, the present disclosure provides a semiconductor material, the semiconductor material is obtained by utilizing the aforementioned multi-line cutting method or the aforementioned multi-line cutting apparatus to cut. The semiconductor material has few geometric defects on the surface, high product yield rate, facilitates subsequent processing, and has strong epitaxial stability.

In some embodiments of the present disclosure, the above-mentioned semiconductor materials may include single crystal silicon wafers, polycrystalline silicon wafers, gallium nitride substrates, sapphire substrates, or silicon carbide substrates.

In another aspect of the present disclosure, the present disclosure provides a power device, which includes the aforementioned semiconductor material. The power device has a high product yield rate and good performance in use.

In some embodiments of the present disclosure, the above-mentioned power devices include diodes, thyristors, or bipolar transistors, etc.

The present disclosure is further explained by specific examples below, however, it should be understood that these examples are only used for more detailed description, and should not be understood as limiting the present disclosure in any form.

### Example 1

Multi-line cutting method including following steps.

The line spool is in contact with the vibrating head of the ultrasonic generating device, and the line spool vibrates under the excitation action of ultrasonic waves with a frequency of 20 kHz. Under the transmission action of the line spool, the cutting line vibrates and the object to be cut is cut. The diameter of the cutting line is 0.2 mm, the moving speed of the cutting line is 500 m/min.

### Example 2

The multi-line cutting method is the same as in Example 1, except that the frequency of the ultrasonic wave is 300 kHz.

### Example 3

The multi-line cutting method is the same as in Example 1, except that the frequency of the ultrasonic wave is 150 kHz.

### Example 4

The multi-line cutting method is the same as in Example 1, except that the frequency of the ultrasonic wave is 25 kHz.

### Example 5

The multi-line cutting method is the same as in Example 1, except that the frequency of the ultrasonic wave is 120 kHz.

### Comparative Example 1

Multi-line cutting method including following steps.

The diameter of the cutting line is 0.2 mm, the moving speed of the cutting line is 500 m/min, and the cutting line cuts without excitation action of the ultrasonic waves.

### Comparative Example 2

Diamond mortar cutting:

mixing the suspension containing diamonds with water, and stirring evenly for 8 hours to obtain diamond mortar. The diamond concentration in diamond mortar is about 150-300 g/L, the line diameter of the cutting line is 0.2 mm, and moving speed of the cutting line is 600 m/min, the cutting line cuts without the excitation action of the ultrasonic waves.

### Comparative Example 3

The multi-line cutting method including:

making the line-entry end of the cutting line contact with a vibrating head with a vibration frequency of 150 kHz, making the cutting line vibrate and cut the object to be cut, wherein the diameter of the cutting line is 0.2 mm, and the moving speed of the cutting line is 500 m/min.

### Comparative Example 4

The multi-line cutting method including:

making the workbench for fixing the object to be cut contact with a vibrating head with a vibration frequency of 150 kHz, the diameter of the cutting line is 0.2 mm, and the moving speed of the cutting line is 500 m/min.

Using the cutting methods of Examples 1-5 and Comparative Examples 1-4 to cut silicon carbide crystal bars with a diameter of 4 inches, the feeding speed of the silicon carbide crystal bars was 1 mm/hr, the test results of the curvature (Warp), the warpage (Bow) and the total thickness variety (TTV) of the product surface obtained after cutting can refer to Table 1.

TABLE 1

| | Warp/Micron | Bow/Micron | TTV/Micron |
|---|---|---|---|
| Example 1 | 41 | 11 | 10 |
| Example 2 | 45 | 9 | 9 |
| Example 3 | 34 | 5 | 8 |
| Example 4 | 38 | 7 | 8 |
| Example 5 | 34 | 6 | 6 |
| Comparative | 46 | 8 | 13 |
| Example 1 | | | |
| Comparative | 45 | 8 | 12 |
| Example 2 | | | |
| Comparative | 55 | 12 | 14 |
| Example 3 | | | |
| Comparative | 63 | 15 | 16 |
| Example 4 | | | |

Although specific embodiments have been used to illustrate and describe the present disclosure, it should be appreciated that many other changes and modifications can be made without departing from the spirit and scope of the present disclosure. Therefore, this means that all these changes and modifications that fall within the scope of the present disclosure are included in the appended claims.

1. A multi-line cutting method, comprises following steps: making a line spool configured to be winded by cutting lines vibrate under an excitation action of an ultrasonic wave; and making the cutting lines vibrate to cut an object to be cut under a transmitting action of the line spool.

2. The multi-line cutting method according to claim 1, wherein the cutting lines resonate with the ultrasonic wave transmitted to the cutting lines.

3. The multi-line cutting method according to claim 1, wherein a vibrating component of an ultrasonic generating device is contacted with the line spool to realize a loading of the ultrasonic wave.

4. The multi-line cutting method according to claim 3, wherein the cutting lines resonate with the ultrasonic wave transmitted to the cutting lines.

5. The multi-line cutting method according to claim 1, wherein a vibration frequency of the ultrasonic wave is 20-300 kHz.

6. The multi-line cutting method according to claim 1, wherein the object to be cut comprises at least one of silicon carbide, sapphire, gallium nitride and silicon.

7. A multi-line cutting apparatus, comprising at least two parallel line spools arranged at intervals;
cutting lines, winding around the line spools; and
an ultrasonic generating device, wherein a vibrating component of the ultrasonic generating device is in contact with at least one of the line spools.

8. A use of the multi-line cutting apparatus according to claim 7 for cutting semiconductor materials.

9. (canceled)

10. (canceled)

11. The multi-line cutting method according to claim 5, wherein a vibration frequency of the ultrasonic wave is 25-120 kHz.

12. The multi-line cutting method according to claim 5, wherein a vibration amplitude of the cutting lines is 1-650 μm.

13. The multi-line cutting method according to claim 5, wherein a diameter of the cutting lines is 0.05-0.3 mm.

14. The multi-line cutting method according to claim 5, wherein a moving speed of the cutting lines is 350-1500 m/min.

15. The multi-line cutting method according to claim 14, wherein a moving speed of the cutting lines is 400-1200 m/min.

16. The multi-line cutting method according to claim 5, wherein a tension of the cutting lines is 25-45 N.

17. The multi-line cutting method according to claim 5, wherein a material of the cutting lines comprises at least one of single crystal diamond, polycrystalline diamond and piano wire.

18. The multi-line cutting method according to claim 17, wherein a material of the cutting lines is single crystal diamond or polycrystalline diamond.

19. The multi-line cutting method according to claim 6, wherein a feeding speed of the object to be cut is 0.5-15 mm/hr.

20. The multi-line cutting apparatus according to claim 7, wherein the line spools each are in a hollow structure, and the vibrating component is located in a corresponding hollow structure.
